(19) United States
(12) Patent Application Publication
(10) Pub. No.: US 2008/0217039 A1
(43) Pub. Date: Sep. 11, 2008

(54) Hand-held power tool with a pneumatic percussion mechanism

(75) Inventors: Josef Fuenfer, Koenigsbrunn (DE); Michael Schamberger, Scheuring (DE)

Correspondence Address: ABELMAN, FRAYNE & SCHWAB, 666 THIRD AVENUE, 10TH FLOOR, NEW YORK, NY, 10017, US

(73) Assignee: Hilti Aktiengesellschaft

(21) Appl. No.: 12/074,836

(22) Filed: Mar. 5, 2008

(30) Foreign Application Priority Data
Mar. 8, 2007 (DE) 10 2007 000 135.7

(51) Int. Cl. B25D 16/00

(52) U.S. Cl. 173/128

(57) ABSTRACT

A hand-held percussion power tool includes a pneumatic mechanism (20) having a guide (21) and a striking member reciprocating in the guide (21), and a braking device (30) for the striking member and including at least one braking member for breakingly engaging the striking member and formed as a pivot lever (31) a pivotal movement of which is controlled by the striking member.

### BACKGROUND OF THE INVENTION

1. Field of the Invention

The present invention relates to a hand-held percussion power tool such as, e.g., chisel hammer or combination hammer and including a pneumatic mechanism having a guide and a striking member reciprocating in the guide, and a braking device for the striking member and including at least one braking member for brakingly engaging the striking member.

2. Description of the Prior Art

Hand-held percussion power tools have a tendency to produce secondary blows when the power tool is lifted off a constructional component or a workpiece, or when the working tool is broken by the workpiece.

German Publication DE 43 10 835 A1 discloses a hand-held electropneumatic percussion or rotary percussion hammer having a percussion mechanism located in the tool housing and including a striking member such as an anvil. An interception or braking device for the striking member has a catching member or a braking member through which the striking member extends, being engaged by the catching or braking member, whereby the catching member intercepts the striking member in case of idle blows by the working tool. The catching member is preloaded in a guide region as a result of elastic deformation but nevertheless is axially displaceable in the guide region when the working tool produces idle blows, which should prevent secondary blows.

The drawback of the known device consists in that the catching or braking path of the catch ring is relatively long so that the striking member before being intercepted, can be displaced over a relatively large path. On the other hand, the axial displacement of the catching member, while being preloaded, causes an increase wear of catching member. Accordingly, an object of the present invention is to provide a hand-held percussion power tool in which the above-discussed drawbacks of the known power tool are eliminated and secondary blows are reliably prevented.

### SUMMARY OF THE INVENTION

These and other objects of the present invention, which will become apparent hereinafter, are achieved by forming the at least one braking member as a pivot lever, a pivotal movement of which is controlled by the striking member. The striking member can be formed, e.g., as an anvil or an impact piston. Forming the at least one braking member as a pivot lever represents a constructively simple solution that guarantees braking of the striking member and reliably prevents secondary blows of the percussion mechanism at an idle stroke. The control of the braking member, which is formed as a pivot lever, by the striking member itself guarantees a direct actuation of the braking device in case of an idle stroke of the working tool or the striking member, which provides for a reduced wear.

Advantageously, a control profile for the pivot lever is provided on the striking member, so that the time of actuation of the braking device can be set preliminary dependent on the stroke of the striking member.

A particularly simple solution can be obtained when the striking member has a first section having a first diameter, and a second section having a second diameter which is smaller than the first diameter, and the control profile is provided in a transition region from the first section to the second section, whereby the control profile is produced by the change of the diameter or the thickness of the striking member such as an anvil or an impact piston. Such a striking member can be produced easily and without increased costs.

It is advantageous to form the control profile by at least one conical control surface. This insures a damage-free, low-wear sliding of the adjusting section of the pivot lever along the control profile.

Advantageously, the pivot lever is pivotably supported on an axially stationary pivot support radially opposite the striking member. Thereby, the pivot lever is mounted axially stationary but pivotally in the guide.

It is also advantageous when the pivot lever has a first pivot arm and a second pivot arm that cooperates with the control profile of the striking member. In this case, the first lever arm can function as a pure braking section and is provided with a braking shoe that engages the surface of the striking member. By forming a two-arm lever, the forces, which are applied to the first lever arm by the second lever arm, can be optimized based on lever principles.

It is further advantageous when the second lever arm has, proceeding from the pivot support, a length that exceeds at least in 1.2 times a length of the first lever arm also proceeding from the pivot support. It is particularly advantageous when the length of the second lever arm has a length greater than the length of the first lever arm from about two times to three and one-half times. This permits to achieve an optimal design of the pivot lever with regard to force/path ratios.

In an advantageous embodiment of the present invention, the second lever arm is resiliently preloaded by an elastic element in a direction of an axial projection of the striking member or directly against the striking member. Thereby, even with already partially worn braking shoes, an adequate braking pressure can be applied to the striking member in the braking position of the pivot lever. This is because the elastic member elastically biases the braking shoe on the second lever arm against the striking member.

In a constructively simple embodiment, the elastic member is arranged radially outwardly of the second lever arm, engaging the second lever arm from above. The elastic member is supported radially outwardly, e.g., against a guide component. E.g., the elastic member can be secured in a cavity of the second lever arm, so that its position is reliably fixed.

The novel features of the present invention, which are considered as characteristic for the invention, are set forth in the appended claims. The invention itself, however, both as to its construction and its mode of operation, together with additional advantages and objects thereof, will be best understood from the following detailed description of preferred embodiments, when read with reference to the accompanying drawings.

### BRIEF DESCRIPTION OF THE DRAWINGS

The drawings show:

FIG. 1 a side view of a hand-held power tool according to the present invention with a pneumatic percussion mechanism;

FIG. 2 a cross-sectional view of a section of the power tool shown in FIG. 1 at an increased, in comparison with FIG. 1, scale and marked with a reference sign II in an operational condition, with the percussion mechanism applying blows to a working tool;

FIG. 3 a view similar to that of FIG. 2 but with the percussion mechanism applying idle blows;

FIG. 4 a view similar to that of FIG. 3 but with the braking device in a braking position; and

FIG. 5 a cross-sectional view of the section II of another embodiment of a hand-held power tool according to the present invention and similar to FIG. 2.

### DETAILED DESCRIPTION OF THE PREFERRED EMBODIMENTS

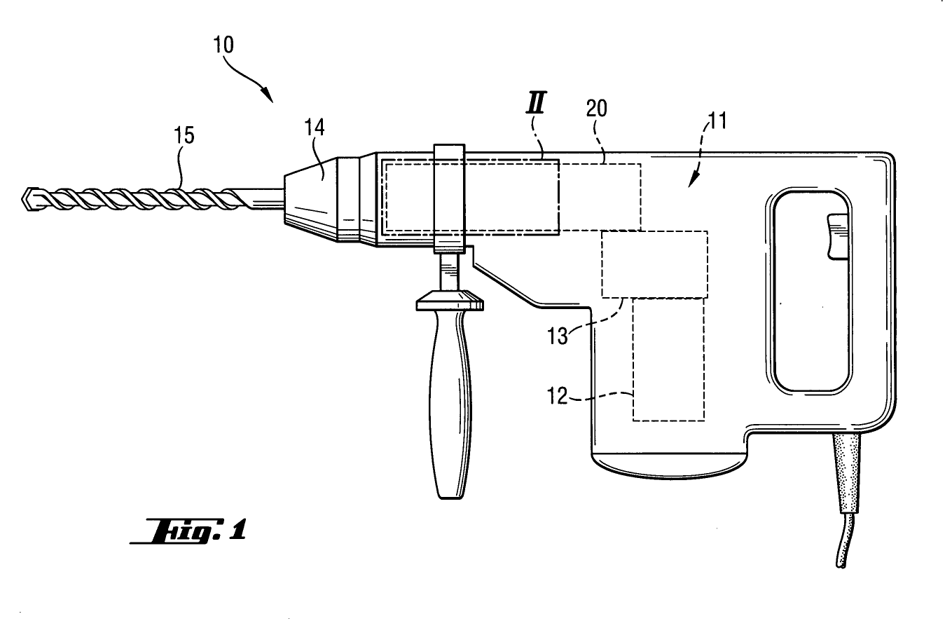

A hand-held power tool 10, which is formed as a rotary-percussion combination hammer and is shown in FIG. 1, includes a housing 11 in which a percussion mechanism 20 that drives a working tool 15 received in a chuck 14, a gear unit 13, and a motor 12 are located. A shaft (not shown in the drawings) connects the percussion mechanism 20 with the gear unit 13 that transmits the rotational movement of the motor 12 to the percussion mechanism 20.

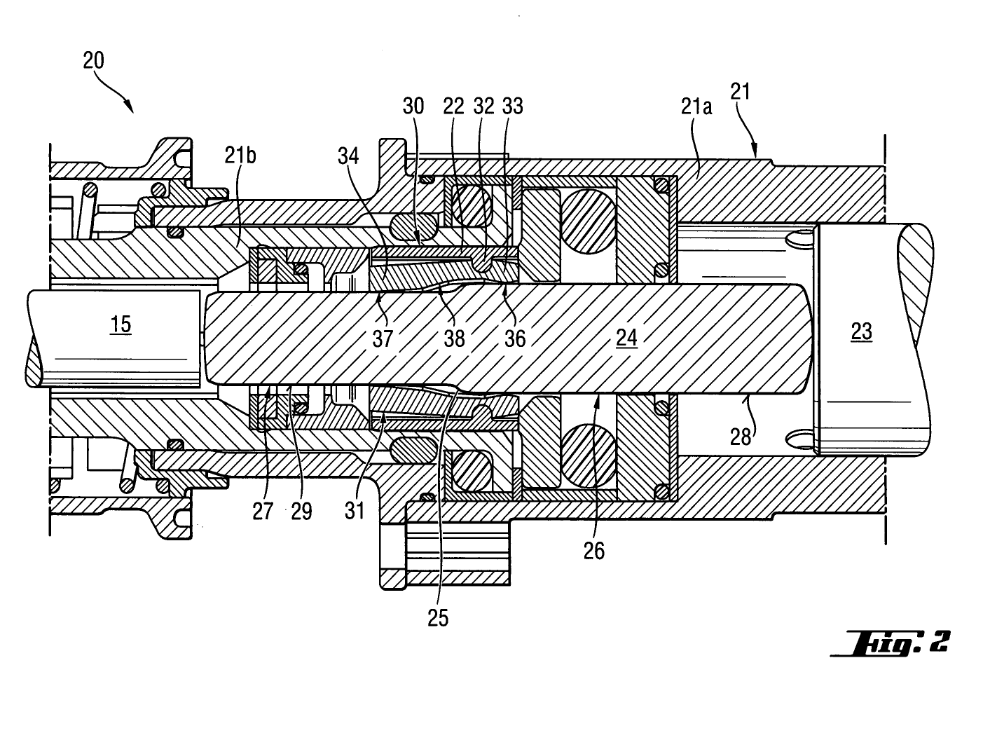

FIGS. 2-4 show a section II of the percussion mechanism in detail. The percussion mechanism 20 has a guide 21 in which a driving member, not shown, such as, e.g., a driving piston, reciprocates. For producing the reciprocating movement during the operation of the power tool 10, the driving member is connected by a connection rod (not shown in the drawings) which is pivotally attached thereto, with an eccentric mounted on the output shaft of the gear unit 13. The driving member drives a percussion piston 23 which is axially displaceable in the guide 21. The percussion piston 23 cooperates with a striking member likewise axially displaceable in the guide 21 and formed as an anvil 24 for transmitting blows to the working tool 15. An air spring (not shown in the drawings) that can be actuated and vented, is located between the driving member and the percussion piston 23 for transmitting the reciprocating movement of the driving member to the percussion piston 23. It should be pointed out that the percussion piston itself can be formed as a striking member.

The guide 21 is formed of several parts and consists of at least a first guide tube 21a and a second guide tube 21b arranged coaxially with the first guide tube 21a. The percussion piston 23 is located in the first guide tube 21a. The anvil 24 is guided in the guide 21 in the direction of the chuck 14 (please see FIG. 1) by other guide elements in front of the percussion piston 23.

The anvil 24 has a first section 20 adjacent to the percussion piston 23 and having a cross-section or a diameter greater than a cross-section or a diameter of a second section 27 remote from the percussion piston 23. Between the first and second sections 26, 27 of the anvil 24, outwardly thereof, a control profile 25 is formed on the anvil 24. The control profile 25 has, e.g., two control surfaces tapering from the first section 26 toward the second section 27. The control surfaces are provided, e.g., in the radially opposite outer areas of the anvil 24.

In the guide 21, and more precisely, in the second guide tube 21b, a braking device, which is generally designated with a reference numeral 30, for the striking member on the anvil 24 is arranged. The braking device 30 has at least two braking elements formed as pivot levers 31 pivotally supported on respective pivot supports 32 which are arranged on a support member 22 such as, e.g., a sleeve, with the pivot supports 32 being formed on the inner surface of the sleeve. The pivot levers 31 are arranged symmetrically about the anvil 24 radially outwardly thereof.

The pivot levers 31 each has a pivot arm extending along a side of a respective pivot support 32 extending in the axial direction, and formed of a first lever arm 33 adjacent to the percussion piston 23 and on which a brake shoe 36 is formed, and a second lever arm 34 remote from the percussion piston 23 and which cooperates with the control profile 25 provided on the anvil 24. A further brake shoe 37 is provided on the second lever arm 34. The brake shoes 36, 37 are provided on the sides of the first and second lever arms 33, 34 adjacent to the anvil 24. The second lever arm 34 has, proceeding from the pivot support 32, a length L₂ that is at least in 1.2 times greater than a length L₁ of the first lever arm 33 proceeding from the pivot support 32. In the embodiment shown in the drawings, the length L₂ of the second lever arm 34 is approximately in three times greater than the length L₁ of the first lever arm 33.

In FIG. 2, the power tool 10 (FIG. 1) is shown in a condition in which it operates in a chisel or percussion mode. The percussion piston 23 applies blows to the anvil 24 that transmits this blows to the end of the working tool 15. The braking device 30 is inactive, and the brake shoe 36, 37 of the pivot lever 31 do not apply any force to the surfaces 28, 29 of the sections 26, 27 of the anvil 24.

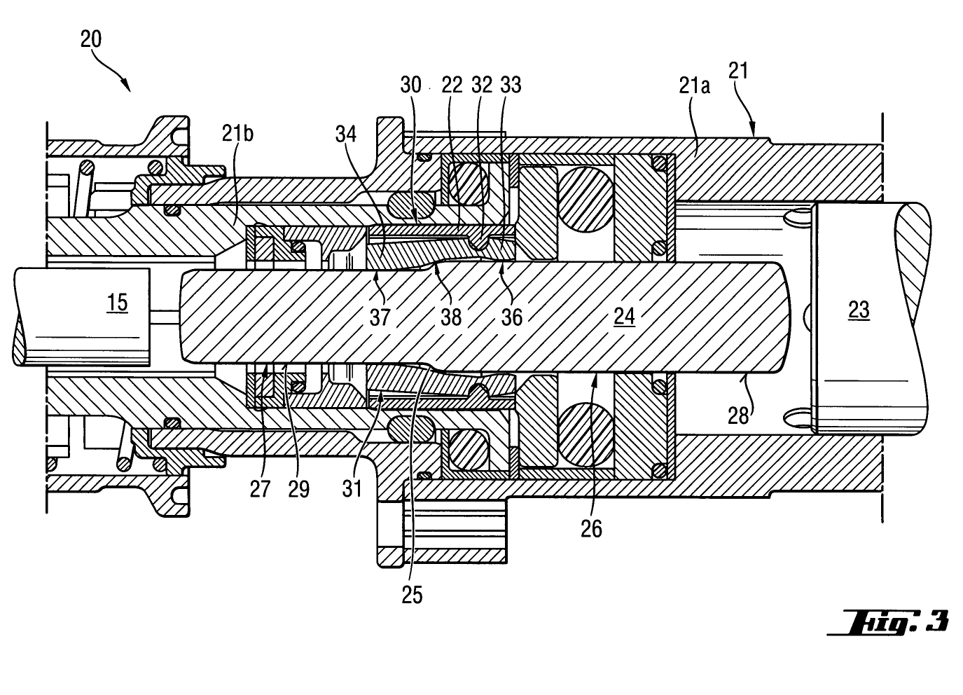

In FIG. 3, the working tool 15 applies idle blows, i.e., it does not produce any force in the direction of the anvil 24. This is because the power tool 10 is not pressed any more by the power tool operator against a to-be-treated workpiece. Thereby, the anvil 24 would be displaced by the reciprocating percussion piston 23 farther in the direction of the working tool 15, which entails displacement of the control profile 25 against an adjusting section 38 of the pivot lever 31, causing pivotal movement of the pivot lever 31, with the second lever arm 34 being pressed radially outwardly.

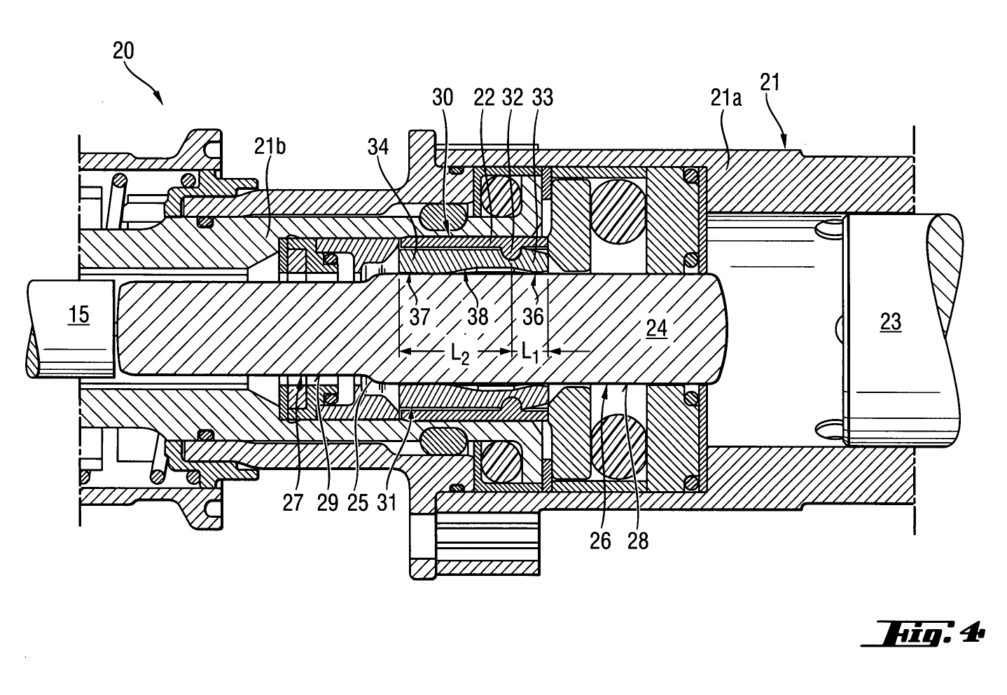

FIG. 4 shows the braking device 30 in its braking position in which the brake shoe 36 on the first lever arm 33 and the brake shoe 37 on the second lever arm 34 both abut the surface 28 of the first section 26 of the anvil 24. In this position of the braking device, the pivot lever 31 reliably holds the anvil 24 in a fixed position and, therefore, secondary blows are reliably prevented. In order to release the braking device 30, the working tool 15 should again be pressed against a to-be-treated workpiece, so that the anvil 24 is displaced by the working tool 15 in the direction of the percussion piston 23.

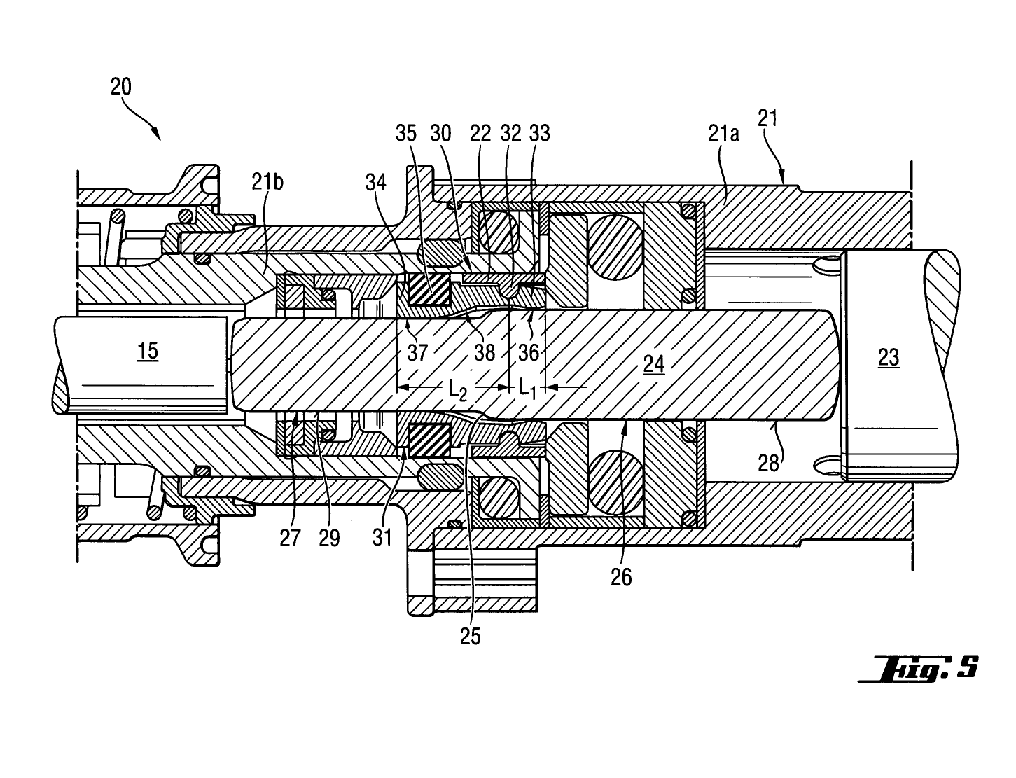

FIG. 5 shows another embodiment of the percussion mechanism 20 of the power tool 10 shown in FIG. 1. The percussion mechanism 20 of the embodiment of the power tool shown in FIG. 5 distinguishes from the percussion mechanism 20 shown in FIGS. 2-4 in that the braking member of the braking device 30, which is formed as a pivot lever 31, is supported at an end of the second lever arm 34 radially outwardly against an elastic member 35 against which, e.g., the second guide tube 2b or a part associated therewith is supported. The function of the pivot lever 31 and the design of the braking device 30 and the percussion mechanism 20 are otherwise the same as those in the embodiment shown in FIGS. 2-4. Therefore, for their descriptions, reference should be made to the description with based on FIGS. 1-4. The elastic member 35 takes care that at a premature wear of the brake shoes 36, 37, they still apply a sufficient pressure to the surface 28 of the anvil 24 in the braking position of the braking device 30 (this particularly relates to the farther brake shoe 37).

Though the present invention was shown and described with references to the preferred embodiments, such are merely illustrative of the present invention and are not to be construed as a limitation thereof and various modifications of the present invention will be apparent to those skilled in the art. It is, therefore, not intended that the present invention be limited to the disclosed embodiments or details thereof, and the present invention includes all variations and/or alternative embodiments within the spirit and scope of the present invention as defined by the appended claims.

What is claimed is:

1. A hand-held percussion power tool, comprising a pneumatic mechanism (20) including a guide (21) and a striking member reciprocating in the guide (21); and a braking device (30) for the striking member and including at least one braking member for breakingly engaging the striking member and formed as a pivot lever (31) a pivotal movement of which is controlled by the striking member.

2. A hand-held power tool according to claim 1, wherein the striking member has a control profile (25) for the pivot lever (31).

3. A hand-held power tool according to claim 2, wherein the striking member has a first section (26) having a first diameter and a second section (27) having a second diameter which is smaller than the first diameter, and wherein the control profile (25) is provided in a transition region from the first section (26) to the second section (27).

4. A hand-held power tool according to claim 2, wherein the control profile (25) is formed by at least one conical control surface.

5. A hand-held power tool according to claim 1, wherein the braking device (30) comprises an axially stationary pivot support (32), and the pivot lever (31) is pivotally supported thereon radially opposite the striking member.

6. A hand-held power tool according to claim 2, wherein the pivot lever (31) has a first pivot arm (33) and a second pivot arm (34) that cooperates with the control profile (25) of the striking member.

7. A hand-held power tool according to claim 6, wherein the second pivot arm (34) has, proceeding from the pivot support (32), a length (L₂) that exceeds at least in 1.2 times a length (L₁) of the first lever arm (33) also proceeding from the pivot support (32).

8. A hand-held power tool according to claim 6, wherein the braking device (30) comprises an elastic member (35) for resiliently preloading the second lever arm (34) in a direction of an axial projection of the striking element.

9. A hand-held power tool according to claim 8, wherein the elastic member (35) is arranged radially outwardly of the second lever arm (34), engaging the second lever arm (34) from above.
